(19) United States
(12) Patent Application Publication
(10) Pub. No.: US 2020/0211562 A1
(43) Pub. Date: Jul. 2, 2020

(54) VOICE RECOGNITION DEVICE AND VOICE RECOGNITION METHOD

(71) Applicant: Mitsubishi Electric Corporation, Tokyo (JP)

(72) Inventors: Wataru YAMAZAKI, Tokyo (JP); Shin KATO, Tokyo (JP); Masanobu OSAWA, Tokyo (JP)

(73) Assignee: Mitsubishi Electric Corporation, Tokyo (JP)

(21) Appl. No.: 16/615,035

(22) PCT Filed: Jun. 22, 2017
(86) PCT No.: PCT/JP2017/023060

§ 371 Date: Nov. 19, 2019

(51) Int. Cl. G10L 15/30; G10L 15/22; G10L 17/26

(52) U.S. Cl. CPC G10L 15/30; G10L 17/26; G10L 15/22

(57) ABSTRACT

A client-side voice recognition device, in a server-client type voice recognition system for performing voice recognition on a user's utterance by using the client-side voice recognition device and a server-side voice recognition device, the client-side voice recognition device including: a voice recognition unit for recognizing the user's utterance; a communication state acquiring unit for acquiring a state of communication with a server device including the server-side voice recognition device; and a vocabulary changing unit for changing a recognition target vocabulary of the voice recognition unit, on the basis of the acquired state of communication.

### TECHNICAL FIELD

The present invention relates to voice recognition technology, and more particularly to server-client type voice recognition.

### BACKGROUND ART

In the related art, a server-client type voice recognition technology is used which executes voice recognition processing on user's uttered voice by linking voice recognition by a server-side voice recognition device with a client-side voice recognition device.

For example, Patent Literature 1 discloses a voice recognition system in which a client-side voice recognition device first performs recognition processing on user's uttered voice, and in a case where the recognition fails, a server-side voice recognition device performs recognition processing on the user's uttered voice.

### CITATION LIST

### Patent Literatures

Patent Literature 1: JP 2007-33901 A

### SUMMARY OF INVENTION

### Technical Problem

In the voice recognition system described in Patent Literature 1 described above, there is a disadvantage that it takes time to acquire a recognition result from the server-side voice recognition device in a case where the client-side voice recognition device fails to recognize, thereby delaying a response to the user's utterance.

The present invention has been made to solve disadvantages as the above, and an object of the present invention is to achieve both a quick response speed to a user's utterance and a high recognition rate of the user's utterance in server-client type voice recognition processing.

### Solution to Problem

A voice recognition device according to the present invention is a client-side voice recognition device, in a server-client type voice recognition system for performing voice recognition on a user's utterance by using the client-side voice recognition device and a server-side voice recognition device, the client-side voice recognition device including: a voice recognition unit for recognizing the user's utterance; a communication state acquiring unit for acquiring a state of communication with a server device including the server-side voice recognition device; and a vocabulary changing unit for changing a recognition target vocabulary of the voice recognition unit, on a basis of the state of communication acquired by the communication state acquiring unit.

### Advantageous Effects of Invention

According to the present invention, it is possible to implement a quick response speed to a user's utterance and a high recognition rate to the user's utterance in server-client type voice recognition.

### BRIEF DESCRIPTION OF DRAWINGS

FIG. 1 is a block diagram illustrating a configuration of a voice recognition device according to a first embodiment.

FIGS. 2A and 2B are diagrams each illustrating an exemplary hardware configuration of the voice recognition device according to the first embodiment.

FIG. 3 is a flowchart illustrating the operation of a vocabulary changing unit of the voice recognition device according to the first embodiment.

FIG. 4 is a flowchart illustrating the operation of a recognition result adopting unit of the voice recognition device according to the first embodiment.

### DESCRIPTION OF EMBODIMENTS

To describe the present invention further in detail, embodiments for carrying out the present invention will be described below with reference to the accompanying drawings.

### First Embodiment

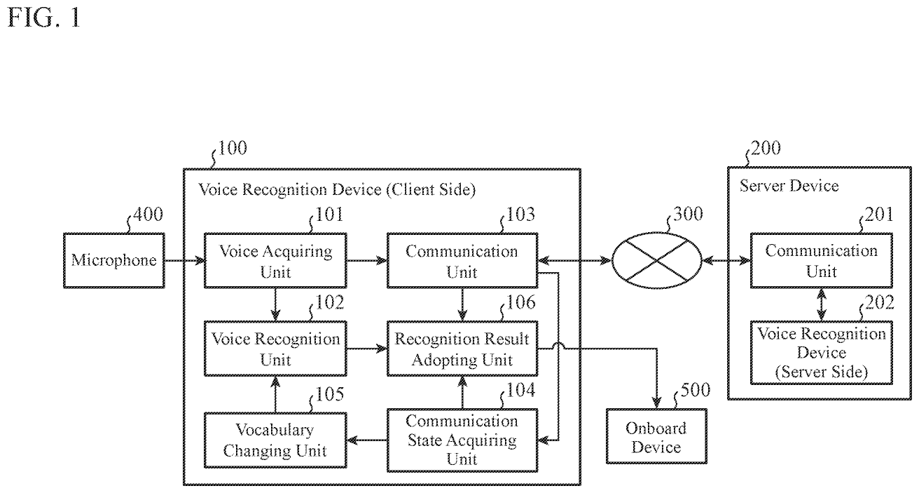

FIG. 1 is a block diagram illustrating a configuration of a voice recognition system according to a first embodiment.

The voice recognition system includes a voice recognition device 100 on a client side and a server device 200. As illustrated in FIG. 1, the client-side voice recognition device 100 is connected with an onboard device 500. In the following, description will be given assuming that the onboard device 500 is a navigation device.

First, the outline of the voice recognition device 100 will be described.

The voice recognition device 100 is a voice recognition device on the client side, and sets, as a recognition target vocabulary, vocabulary indicating addresses and vocabulary indicating facility names (hereinafter referred to as “large vocabulary”). The client-side voice recognition device 100 also sets, as a recognition target vocabulary, vocabulary indicating operation commands instructing operation on the onboard device 500 which is a target to be operated by voice and vocabulary registered in advance by a user (hereinafter referred to as “command vocabulary”). Here, the vocabulary registered in advance by a user includes, for example, registered names of places and names of individuals in an address book.

The client-side voice recognition device 100 has less hardware resources and a lower processing capacity of the central processing unit (CPU) as compared to a server-side voice recognition device 202 which will be described later. Meanwhile, the large vocabulary has a huge number of items as recognition targets. Therefore, the recognition performance, on the large vocabulary, of the client-side voice recognition device 100 is inferior to the recognition performance, on the large vocabulary, of the server-side voice recognition device 202.

Moreover, since the client-side voice recognition device 100 has less hardware resources and lower processing capacity of the CPU as described above, the client-side voice recognition device 100 cannot recognize the command vocabulary unless the same utterance as an operation command registered in a recognition dictionary is made. Therefore, the client-side voice recognition device 100 has a lower degree of freedom in accepting utterances as compared to the server-side voice recognition device 202.

On the other hand, unlike the server-side voice recognition device 202, the client-side voice recognition device 100 has the advantage that the response speed to a user's utterance is fast, because there is no need to transmit or receive data via a communication network 300. In addition, the client-side voice recognition device 100 can perform voice recognition on a user's utterance regardless of the communication state.

Next, the outline of the voice recognition device 202 will be described.

The voice recognition device 202 is a voice recognition device on the server side, and sets the large vocabulary and the command vocabulary as a recognition target vocabulary. The server-side voice recognition device 202 is rich in hardware resources and has a high CPU processing capacity, and thus has superior performance in recognizing the large vocabulary compared to the client-side voice recognition device 100.

Meanwhile, since the server-side voice recognition device 202 needs to transmit and receive data via the communication network 300, the response speed to a user's utterance is slow as compared to the client-side voice recognition device 100. Moreover, when connection for communication with the client-side voice recognition device 100 cannot be established, the server-side voice recognition device 202 cannot acquire voice data of a user's utterance and thus cannot perform voice recognition.

In the voice recognition system according to the first embodiment, when connection for communication between server-side voice recognition device 202 and the client-side voice recognition device 100 is not established, the client-side voice recognition device 100 performs voice recognition on voice data of the user's utterance using the large vocabulary and the command vocabulary as a recognition target, and outputs a voice recognition result.

On the other hand, when connection for communication between the server-side voice recognition device 202 and the client-side voice recognition device 100 is established, the client-side voice recognition device 100 and the server-side voice recognition device 202 perform voice recognition in parallel on the voice data of the user's utterance. At this time, the client-side voice recognition device 100 excludes the large vocabulary from the recognition target vocabulary, and changes the recognition target vocabulary to be limited only to the command vocabulary. That is, the client-side voice recognition device 100 activates only the recognition dictionary in which the command vocabulary is registered.

The voice recognition system outputs, as the voice recognition result, either the recognition result by the client-side voice recognition device 100 or the recognition result by the server-side voice recognition device 202.

Specifically, in a case where the reliability of the recognition result by the client-side voice recognition device 100 is greater than or equal to a predetermined threshold value, the voice recognition system outputs, as the voice recognition result, the recognition result by the client-side voice recognition device 100.

On the other hand, in a case where the reliability of the recognition result by the client-side voice recognition device 100 is less than the predetermined threshold value and the recognition result is received from server-side voice recognition device 202 within a preset stand-by time, the voice recognition system outputs, as the voice recognition result, the received recognition result by the server-side voice recognition device 202. Additionally, in a case where the reliability of the recognition result by the client-side voice recognition device 100 is less than the predetermined threshold value and the recognition result cannot be received from the server-side voice recognition device 202 within the stand-by time, the voice recognition system outputs information indicating that voice recognition has failed.

When the connection for communication between the server-side voice recognition device 202 and the client-side voice recognition device 100 is established, the client-side voice recognition device 100 limits the recognition target vocabulary to the command vocabulary. Therefore, when the user utters a command, it is possible to prevent the client-side voice recognition device 100 from erroneously recognizing an address name or a facility name acoustically similar to the command. As a result, the recognition rate of the client-side voice recognition device 100 is improved, and the response speed becomes faster.

Meanwhile, when the user utters an address name or a facility name, since the client-side voice recognition device 100 does not set the large vocabulary as the recognition target vocabulary, it is likely that the voice recognition fails or that a recognition result for some command is obtained as a recognition result with low reliability. As a result, when the user utters an address name or a facility name, the voice recognition system outputs, as the voice recognition result, a recognition result received from the server-side voice recognition device 202 having high recognition performance.

Next, the configuration of the client-side voice recognition device 100 will be described.

The client-side voice recognition device 100 includes a voice acquiring unit 101, a voice recognition unit 102, a communication unit 103, a communication state acquiring unit 104, a vocabulary changing unit 105, and a recognition result adopting unit 106.

The voice acquiring unit 101 captures voice uttered by a user via a microphone 400 connected thereto. The voice acquiring unit 101 performs analog/digital (A/D) conversion on the captured uttered voice, for example, by using pulse code modulation (PCM). The voice acquiring unit 101 outputs the converted digitized voice data to the voice recognition unit 102 and the communication unit 103.

The voice recognition unit 102 detects, from the digitized voice data input from the voice acquiring unit 101, a voice section corresponding to the content spoken by the user (hereinafter referred to as “an utterance section”). The voice recognition unit 102 extracts the feature amount of voice data of the detected utterance section. The voice recognition unit 102 performs voice recognition on the extracted feature amount, by using, as a recognition target, a recognition target vocabulary indicated by the vocabulary changing unit 105 to be described later. The voice recognition unit 102 outputs a result of the voice recognition to the recognition result adopting unit 106. As a voice recognition method of the voice recognition unit 102, for example, a general method such as the Hidden Markov Model (HMM) is applicable. The voice recognition unit 102 has recognition dictionaries (not illustrated) for recognizing the large vocabulary and the command vocabulary. When a recognition target vocabulary is indicated by the vocabulary changing unit 105 to be described later, the voice recognition unit 102 activates a recognition dictionary corresponding to the indicated recognition target vocabulary.

The communication unit 103 establishes connection for communication with a communication unit 201 of the server device 200 via the communication network 300. The communication unit 103 transmits the digitized voice data input from the voice acquiring unit 101 to the server device 200. The communication unit 103 also receives a recognition result by server-side voice recognition device 202, the recognition result being transmitted from the server device 200, as will be described later. The communication unit 103 outputs the received recognition result by the server-side voice recognition device 202 to the recognition result adopting unit 106.

Furthermore, the communication unit 103 determines whether connection for communication with the communication unit 201 of the server device 200 can be established, at a predetermined cycle. The communication unit 103 outputs the determination result to the communication state acquiring unit 104.

On the basis of the determination result input from the communication unit 103, the communication state acquiring unit 104 acquires information indicating whether communication can be performed. The communication state acquiring unit 104 outputs the information indicating whether communication can be performed, to the vocabulary changing unit 105 and the recognition result adopting unit 106. The communication state acquiring unit 104 may acquire the information indicating whether communication can be performed, from an external device.

On the basis of the information indicating whether communication can be performed, input from the communication state acquiring unit 104, the vocabulary changing unit 105 determines a vocabulary to be recognized by the voice recognition unit 102, and instructs the voice recognition unit 102. Specifically, the vocabulary changing unit 105 refers to the information indicating whether communication can be performed and when connection for communication with the communication unit 201 of the server device 200 cannot be established, instructs the voice recognition unit 102 to set the large vocabulary and the command vocabulary as a recognition target vocabulary. On the other hand, when connection for communication with the communication unit 201 of the server device 200 can be established, the vocabulary changing unit 105 instructs the voice recognition unit 102 to set the command vocabulary as a recognition target vocabulary.

On the basis of the information indicating whether communication can be performed, input from the communication state acquiring unit 104, the recognition result adopting unit 106 adopts one of the voice recognition result by the client-side voice recognition device 100, the voice recognition result by the server-side voice recognition device 202, and failure in voice recognition. The recognition result adopting unit 106 outputs the adopted information to the onboard device 500.

Specifically, when connection for communication between the communication unit 103 and the communication unit 201 of the server device 200 cannot be established, the recognition result adopting unit 106 determines whether the reliability of the recognition result input from the voice recognition unit 102 is greater than or equal to a predetermined threshold value. In a case where the reliability of the selected voice recognition result is greater than or equal to the predetermined threshold value, the recognition result adopting unit 106 outputs the recognition result to the onboard device 500 as a voice recognition result. On the other hand, in a case where the reliability of the selected recognition result is less than the predetermined threshold value, the recognition result adopting unit 106 outputs, to the onboard device 500, information indicating that voice recognition has failed.

Meanwhile, when connection for communication between the communication unit 103 and the communication unit 201 of the server device 200 can be established, the recognition result adopting unit 106 determines whether the reliability of the recognition result input from the voice recognition unit 102 is greater than or equal to the predetermined threshold value. In a case where the reliability of the selected recognition result is greater than or equal to the predetermined threshold value, the recognition result adopting unit 106 outputs the recognition result to the onboard device 500 as a voice recognition result. On the other hand, in a case where the reliability of the selected recognition result is less than the predetermined threshold value, the recognition result adopting unit 106 waits for the recognition result by the server-side voice recognition device 202 to be input via the communication unit 103. When having acquired the recognition result from the server-side voice recognition device 202 within the preset stand-by time, the recognition result adopting unit 106 outputs the acquired recognition result to the onboard device 500 as a voice recognition result. On the other hand, when the recognition result has not been acquired from the server-side voice recognition device 202 within the preset stand-by time, the recognition result adopting unit 106 outputs information indicating that voice recognition has failed, to the onboard device 500.

Next, the configuration of the server device 200 will be described.

The server device 200 includes the communication unit 201 and the voice recognition device 202.

The communication unit 201 establishes connection for communication with the communication unit 103 of the client-side voice recognition device 100 via the communication network 300. The communication unit 201 receives voice data transmitted from the client-side voice recognition device 100. The communication unit 201 outputs the received voice data to the server-side voice recognition device 202. The communication unit 201 also transmits a recognition result by the server-side voice recognition device 202 to be described later, to the client-side voice recognition device 100.

The server-side voice recognition device 202 detects an utterance section from the voice data input from the communication unit 201, and extracts the feature amount of voice data of the detected utterance section. The server-side voice recognition device 202 sets the large vocabulary and the command vocabulary as a recognition target vocabulary, and performs voice recognition on the extracted feature amount. The server-side voice recognition device 202 outputs the recognition result to the communication unit 201.

Next, an example of a hardware configuration of the voice recognition device 100 will be described.

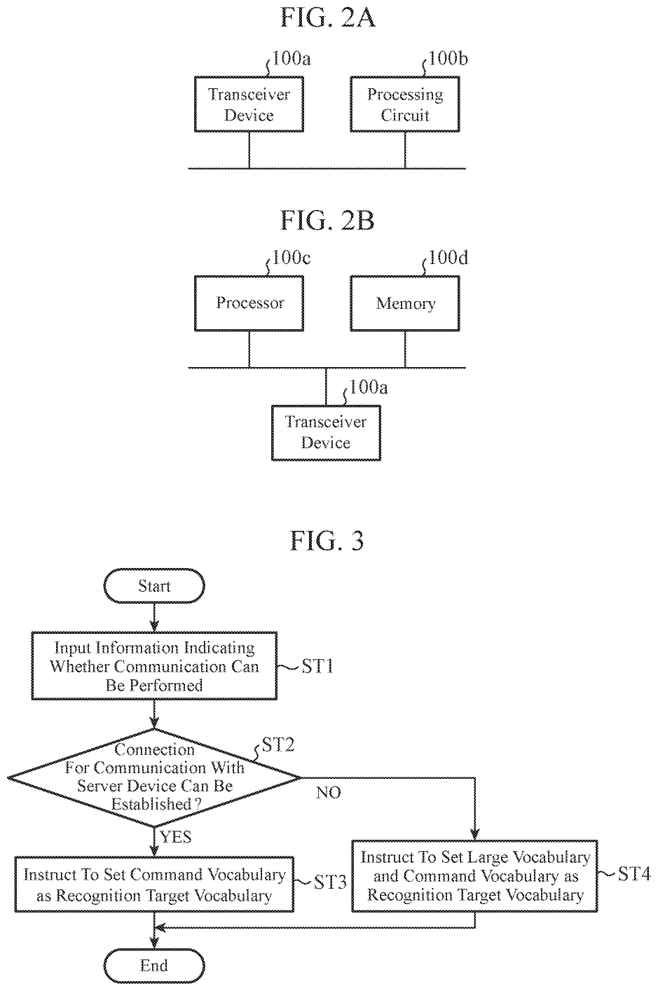

FIGS. 2A and 2B are diagrams illustrating exemplary hardware configurations of the voice recognition device 100.

The communication unit 103 in the voice recognition device 100 corresponds a transceiver device 100a that performs wireless communication with the communication unit 201 of the server device 200. The respective functions of the voice acquiring unit 101, the voice recognition unit 102, the communication state acquiring unit 104, the vocabulary changing unit 105, and the recognition result adopting unit 106 in the voice recognition device 100 are implemented by a processing circuit. That is, the voice recognition device 100 includes the processing circuit for implementing the above functions. The processing circuit may be a processing circuit 100b which is dedicated hardware as illustrated in FIG. 2A, or may be a processor 100c for executing programs stored in a memory 100d as illustrated in FIG. 2B.

In the case where the voice acquiring unit 101, the voice recognition unit 102, the communication state acquiring unit 104, the vocabulary changing unit 105, and the recognition result adopting unit 106 are implemented by dedicated hardware as illustrated in FIG. 2A, the processing circuit 100b corresponds to, for example, a single circuit, a composite circuit, a programmed processor, a parallel-programmed processor, an application specific integrated circuit (ASIC), a field-programmable gate array (FPGA), or a combination thereof. The functions of the respective units of the voice acquiring unit 101, the voice recognition unit 102, the communication state acquiring unit 104, the vocabulary changing unit 105, and the recognition result adopting unit 106 may be separately implemented by processing circuits, or the functions of the respective units may be collectively implemented by one processing circuit.

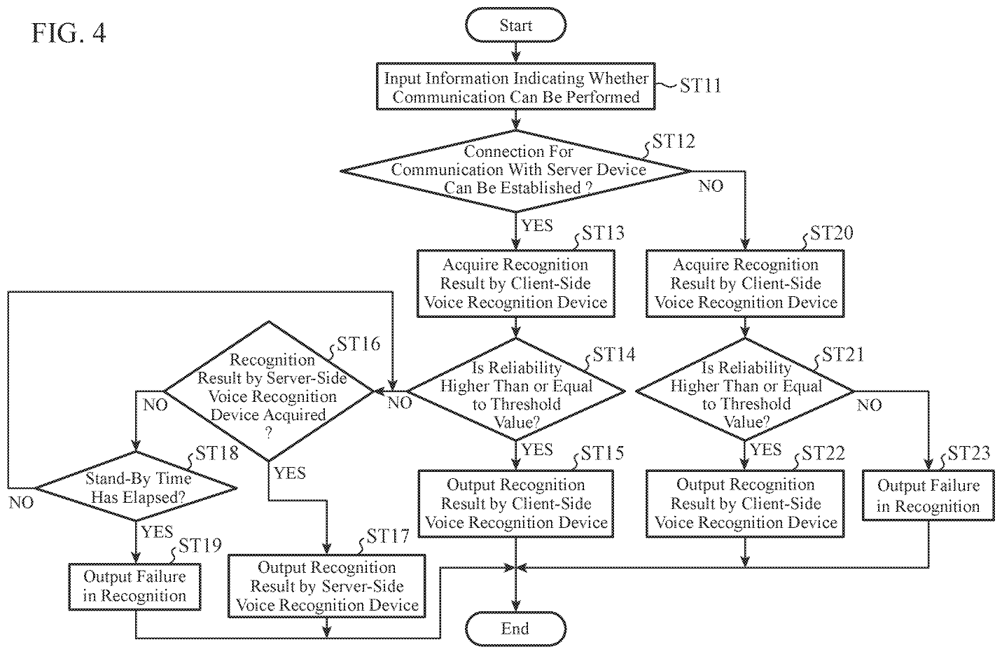

As illustrated in FIG. 2B, in the case where the voice acquiring unit 101, the voice recognition unit 102, the communication state acquiring unit 104, the vocabulary changing unit 105, and the recognition result adopting unit 106 are implemented by the processor 100c, the functions of the respective units are implemented by software, firmware, or a combination of software and firmware. The software or the firmware is described as a program and stored in the memory 100d. By reading out and executing the program stored in the memory 100d, the processor 100c implements the functions of the voice acquiring unit 101, the voice recognition unit 102, the communication state acquiring unit 104, the vocabulary changing unit 105, and the recognition result adopting unit 106. That is, the voice acquiring unit 101, the voice recognition unit 102, the communication state acquiring unit 104, the vocabulary changing unit 105, and the recognition result adopting unit 106 include the memory 100d for storing a program execution of which by the processor 100c results in execution of steps illustrated in FIGS. 3 and 4, which will be described later. In addition, it can be said that these programs cause a computer to execute the procedures or methods of the voice acquiring unit 101, the voice recognition unit 102, the communication state acquiring unit 104, the vocabulary changing unit 105, and the recognition result adopting unit 106.

Here, the processor 100c may include, for example, a CPU, a processing device, an arithmetic device, a processor, a microprocessor, a microcomputer, a digital signal processor (DSP), or the like.

The memory 100d may be a nonvolatile or volatile semiconductor memory such as a random access memory (RAM), a read only memory (ROM), a flash memory, an erasable programmable ROM (EPROM), an electrically EPROM (EEPROM), a magnetic disk such as a hard disk or a flexible disk, or an optical disk such as a mini disk, a compact disc (CD), or a digital versatile disc (DVD).

Note that some of the functions of the voice acquiring unit 101, the voice recognition unit 102, the communication state acquiring unit 104, the vocabulary changing unit 105, and the recognition result adopting unit 106 may be implemented by dedicated hardware, and some thereof may be implemented by software or firmware. In this manner, the processing circuit 100b in the voice recognition device 100 can implement the above functions by hardware, software, firmware, or a combination thereof.

Next, the operation of the voice recognition device 100 will be described.

First, setting of a recognition target vocabulary will be described with reference to a flowchart of FIG. 3.

FIG. 3 is a flowchart illustrating the operation of the vocabulary changing unit 105 of the voice recognition device 100 according to the first embodiment.

When information indicating whether communication can be performed is input from the communication state acquiring unit 104 (step ST1), the vocabulary changing unit 105 refers to the input information indicating whether communication can be performed and determines whether connection for communication with the communication unit 201 of the server device 200 can be established (step ST2). If connection for communication with the communication unit 201 of the server device 200 can be established (step ST2: YES), the vocabulary changing unit 105 instructs the voice recognition unit 102 to set the command vocabulary as a recognition target vocabulary (step ST3). On the other hand, if connection for communication with the communication unit 201 of the server device 200 cannot be established (step ST2: NO), the vocabulary changing unit 105 instructs the voice recognition unit 102 to set the large vocabulary and the command vocabulary as a recognition target vocabulary (step ST4). When the processing of step ST3 or step ST4 has been performed, the vocabulary changing unit 105 terminates the processing.

Next, adoption of a recognition result will be described with reference to a flowchart of FIG. 4.

FIG. 4 is a flowchart illustrating the operation of the recognition result adopting unit 106 of the voice recognition device 100 according to the first embodiment. Note that the voice recognition unit 102 determines which recognition dictionary to be activated, depending on a recognition target vocabulary indicated on the basis of the flowchart of FIG. 3 described above.

When information indicating whether communication can be performed is input from the communication state acquiring unit 104 (step ST11), the recognition result adopting unit 106 refers to the input information indicating whether communication can be performed and determines whether connection for communication with the communication unit 201 of the server device 200 can be established (step ST12). If connection for communication with the communication unit 201 of the server device 200 can be established (step ST12: YES), the recognition result adopting unit 106 acquires a recognition result input from the voice recognition unit 102 (step ST13). The recognition result acquired by the recognition result adopting unit 106 in step ST13 is a result obtained from recognition processing by the voice recognition unit 102 with only the recognition dictionary of the command vocabulary being valid.

The recognition result adopting unit 106 determines whether the reliability of the recognition result acquired in step ST13 is greater than or equal to a predetermined threshold value (step ST14). If the reliability is greater than or equal to the predetermined threshold value (step ST14: YES), the recognition result adopting unit 106 outputs the recognition result by the voice recognition unit 102 acquired in step ST13 to the onboard device 500 as a voice recognition result (step ST15). Then, the recognition result adopting unit 106 terminates the processing.

On the other hand, if the reliability is not greater than or equal to the predetermined threshold value (step ST14: NO), the recognition result adopting unit 106 determines whether a recognition result by the server-side voice recognition device 202 has been acquired (step ST16). If the recognition result by the server-side voice recognition device 202 has been acquired (step ST16: YES), the recognition result adopting unit 106 outputs the recognition result by the server-side voice recognition device 202 to the onboard device 500 as a voice recognition result (step ST17). Then, the recognition result adopting unit 106 terminates the processing.

On the other hand, when the recognition result by the server-side voice recognition device 202 has not been acquired (step ST16: NO), the recognition result adopting unit 106 determines whether a preset stand-by time has elapsed (step ST18). If the preset stand-by time has not elapsed (step ST18: NO), the processing returns to the determination processing of step ST16. On the other hand, if the preset stand-by time has elapsed (step ST18: YES), the recognition result adopting unit 106 outputs information indicating that voice recognition has failed to the onboard device 500 (step ST19). Then, the recognition result adopting unit 106 terminates the processing.

If connection for communication with the communication unit 201 of the server device 200 cannot be established (step ST12: NO), the recognition result adopting unit 106 acquires the recognition result input from the voice recognition unit 102 (step ST20). The recognition result acquired by the recognition result adopting unit 106 in step ST13 is a result obtained from recognition processing by the voice recognition unit 102 with the recognition dictionaries of the large vocabulary and the command vocabulary being valid.

The recognition result adopting unit 106 determines whether the reliability of the recognition result acquired in step ST20 is greater than or equal to the predetermined threshold value (step ST21). If the reliability is greater than or equal to the predetermined threshold value (step ST21: YES), the recognition result adopting unit 106 outputs the recognition result by the voice recognition unit 102 acquired in step ST20 to the onboard device 500 as a voice recognition result (step ST22). Then, the recognition result adopting unit 106 terminates the processing. On the other hand, if the reliability is not greater than or equal to the predetermined threshold value (step ST21: NO), the recognition result adopting unit 106 outputs information indicating that voice recognition has failed to the onboard device 500 (step ST23). Then, the recognition result adopting unit 106 terminates the processing.

Note that, in addition to the above-described configuration, the communication state acquiring unit 104 may further include a component for acquiring information for predicting a communication state between the communication unit 103 and the communication unit 201 of the server device 200. Here, the information for predicting a communication state is information for predicting whether the connection for communication between the communication unit 103 and the communication unit 201 of the server device 200 is likely to be disabled within a predetermined period of time. Specifically, the information for predicting a communication state is information such as information indicating that the vehicle provided with the client-side voice recognition device 100 enters a tunnel after 30 seconds or a tunnel 1 km ahead. The communication state acquiring unit 104 acquires the information for predicting a communication state from an external device (not illustrated) via the communication unit 103. The communication state acquiring unit 104 outputs the acquired information for predicting a communication state to the vocabulary changing unit 105 and the recognition result adopting unit 106.

The vocabulary changing unit 105 indicates a recognition target vocabulary to the voice recognition unit 102, on the basis of the information indicating whether communication can be performed and a prediction result of a state in which the communication is likely to be disabled, the information being input from the communication state acquiring unit 104. Specifically, when connection for communication between the communication unit 103 and the communication unit 201 of the server device 200 cannot be established, or when it is determined that the communication is likely to be disabled within a predetermined period of time, the vocabulary changing unit 105 instructs the voice recognition unit 102 to set the large vocabulary and the command vocabulary as a recognition target vocabulary. On the other hand, when connection for communication with the communication unit 201 of the server device 200 can be established and when it is determined that the communication is not likely to be disabled within the predetermined period of time, the vocabulary changing unit 105 instructs the voice recognition unit 102 to set the command vocabulary as a recognition target vocabulary.

The recognition result adopting unit 106 adopts one of the voice recognition result by the client-side voice recognition device 100, the voice recognition result by the server-side voice recognition device 202, and failure in voice recognition, on the basis of the information indicating whether communication can be performed and a prediction result of a state in which the communication is likely to be disabled, the information being input from the communication state acquiring unit 104.

Specifically, when connection for communication between the communication unit 103 and the communication unit 201 of the server device 200 cannot be established, or when it is determined that the communication is likely to be disabled within the predetermined period of time, the recognition result adopting unit 106 determines whether the reliability of the recognition result input from the voice recognition unit 102 is greater than or equal to the predetermined threshold value.

On the other hand, when connection for communication between the communication unit 103 and the communication unit 201 of the server device 200 can be established and when it is determined that the communication is not likely to be disabled within the predetermined period of time, the recognition result adopting unit 106 determines whether the reliability of the recognition result input from the voice recognition unit 102 is greater than or equal to the predetermined threshold value. The recognition result adopting unit 106 also waits for the recognition result by the server-side voice recognition device 202 to be input as necessary.

As described above, according to the first embodiment, in the server-client type voice recognition system for performing voice recognition on a user's utterance by using the client-side voice recognition device 100 and the server-side voice recognition device 202, the client-side voice recognition device 100 includes: the voice recognition unit 101 for recognizing the user's utterance; the communication state acquiring unit 104 for acquiring a state of communication with the server device 200 including the server-side voice recognition device 202; and the vocabulary changing unit 105 for changing a recognition target vocabulary of the voice recognition unit 102 on the basis of the acquired state of communication. Therefore, it is possible to implement a quick response speed to the user's utterance and a high recognition rate of the user's utterance.

Moreover, according to the first embodiment, the voice recognition unit 102 sets the command vocabulary and the large vocabulary as the recognition target vocabulary, and when the state of communication acquired by the communication state acquiring unit 104 indicates that communication with the server device 200 can be performed, the vocabulary changing unit 105 changes the recognition target vocabulary of the voice recognition unit 102 to the command vocabulary, and when the state of communication acquired by the communication state acquiring unit 104 indicates that communication with the server device 200 cannot be performed, the vocabulary changing unit 105 changes the recognition target vocabulary of the voice recognition unit 102 to the command vocabulary and the large vocabulary. Therefore, it is possible to implement a quick response speed to the user's utterance and a high recognition rate of the user's utterance.

Furthermore, according to the first embodiment, further included is the recognition result adopting unit 106 for adopting one of a recognition result by the voice recognition unit 101, a recognition result by the server-side voice recognition device 202, and failure in voice recognition, on the basis of the state of communication acquired by the communication state acquiring unit 104 and reliability of the recognition result by the voice recognition unit. Therefore, it is possible to implement a quick response speed to the user's utterance and a high recognition rate of the user's utterance.

In addition, according to the first embodiment, the communication state acquiring unit 104 acquires information for predicting the state of communication with the server device 200, and the vocabulary changing unit 105 refers to the information for predicting the state of communication acquired by the communication state acquiring unit 104, and when it is determined that the state of communication is likely to be a communication-disabled state within a predetermined period of time, changes the recognition target vocabulary of the voice recognition unit 102 to the command vocabulary. Therefore, it is possible to prevent deterioration in the communication state in the middle of the voice recognition processing. As a result, the voice recognition device 100 can reliably acquire a voice recognition result and output the voice recognition result to the onboard device 500.

Note that the present invention may include modification of any component of the embodiment, or omission of any component of the embodiment within the scope of the present invention.

### INDUSTRIAL APPLICABILITY

A voice recognition device according to the present invention is used in a device or the like for performing voice recognition processing on a user's utterance in an environment where a communication state changes as a mobile body moves.

### REFERENCE SIGNS LIST

100, 202: Voice recognition device, 101: Voice acquiring unit, 102: Voice recognition unit, 103, 201: Communication unit, 104: Communication state acquiring unit, 105: Vocabulary changing unit, 106: Recognition result adopting unit, 200: Server device.

1. A client-side voice recognition device, in a server-client type voice recognition system to perform voice recognition on a user's utterance by using the client-side voice recognition device and a server-side voice recognition device, the client-side voice recognition device comprising:
processing circuitry
to recognize the user's utterance;
to acquire a state of communication with a server device including the server-side voice recognition device; and
to change a recognition target vocabulary of the processing circuitry, on a basis of the acquired state of communication,
wherein the processing circuitry sets a command vocabulary and a large vocabulary as the recognition target vocabulary, and
when the acquired state of communication indicates that communication with the server device can be performed, the processing circuitry changes the recognition target vocabulary to the command vocabulary, and
when the acquired state of communication indicates that communication with the server device cannot be performed, the processing circuitry changes the recognition target vocabulary to the command vocabulary and the large vocabulary.

2. (canceled)

3. The voice recognition device according to claim 1, wherein
the processing circuitry adopts one of a recognition result by the processing circuitry, a recognition result by the server-side voice recognition device, and failure in voice recognition, on a basis of the acquired state of communication and reliability of the recognition result by the processing circuitry.

4. The voice recognition device according to claim 111,
wherein the processing circuitry acquires information for predicting the state of communication with the server device, and
the processing circuitry refers to the acquired information for predicting the state of communication, and when it is determined that the state of communication is likely to be a communication-disabled state within a predetermined period of time, changes the recognition target vocabulary to the command vocabulary.

5. A voice recognition method of performing server-client type voice recognition on a user's utterance by using a client-side voice recognition device and a server-side voice recognition device, the voice recognition method comprising:
recognizing the user's utterance;
acquiring a communication state between the client-side voice recognition device and a server device including the server-side voice recognition device; and
changing a recognition target vocabulary used for recognition of the user's utterance, on a basis of the acquired communication state,
wherein a command vocabulary and a large vocabulary are set as the recognition target vocabulary, and
when the acquired state of communication indicates that communication with the server device can be performed, the recognition target vocabulary is changed to the command vocabulary, and
when the acquired state of communication indicates that communication with the server device cannot be performed, the recognition target vocabulary is changed to the command vocabulary and the large vocabulary.
